(19) United States
(12) Patent Application Publication
(10) Pub. No.: US 2016/0245938 A1
(43) Pub. Date: Aug. 25, 2016

(54) METHOD AND DEVICE FOR INCREASING FREQUENCY OF SEISMIC DIGITAL SIGNAL

(71) Applicants: CHINA PETROLEUM & CHEMICAL CORPORATION, Beijing (CN); SINOPEC GEOPHYSICAL RESEARCH INSTITUTE, Jiangsu (CN)

(72) Inventors: Zhicheng LIU, Nanjing, Jiangsu (CN); Jin'e XIE, Nanjing, Jiangsu (CN); Chunmei JIA, Nanjing, Jiangsu (CN); Lin SONG, Nanjing, Jiangsu (CN); Lu XU, Nanjing, Jiangsu (CN)

(73) Assignees: China Petroleum & Chemical Corporation, Beijing (CN); Sinopec Geophysical Research Institute, Nanjing, Jiangsu (CN)

(21) Appl. No.: 15/024,739

(22) PCT Filed: Sep. 25, 2013
(86) PCT No.: PCT/CN2013/084238

§ 371 Date: Mar. 24, 2016

(51) Int. Cl. G01V 1/28

(52) U.S. Cl. CPC G01V 1/288; G01V 2210/1234

(57) ABSTRACT

A frequency increasing processing method of a digital signal includes the following steps: S101, inputting a real signal trace collected in a certain period of time; S102, performing Hilbert transform on the real signal trace so as to obtain an instantaneous amplitude trace of the real signal trace; S103, based on the instantaneous amplitude trace, performing frequency increasing and polarity transform processing on the real signal trace so as to obtain a frequency increasing signal trace. Thus, a weak signal source can be identified without a large number of strong events. This shows advantages of environmental protection and cost reduction in the field of shale gas hydraulic fracturing micro-seismic monitoring. In addition, the zero polarity transform and frequency increasing processing in the present invention are simple in steps and are highly universal.

### FIELD OF THE INVENTION

The present disclosure relates to the technical field of digital signal processing, and particularly to a method and a device for increasing frequency of seismic digital signal. More specifically, the present disclosure relates to the analyzing and processing of micro-seismic monitoring data generated during fracturing exploitation procedure of shale gas.

### BACKGROUND OF THE INVENTION

Shale gas is an important unconventional gas resource, and is mainly exploited through hydraulic fracture process. That is, a mixture of chemical substances and a large amount of water and silt is injected into an underground well with high pressure, so that the surrounding rock structures are fractured and then the gas can be collected. During the procedure when the rock cracks, seismic wave with a weak strength would be generated, and this phenomenon is called as “micro-seismic.”

The micro-seismic monitoring technology is a kind of geophysical technology that through observing and analyzing small seismic events that are generated in production activities, the influences and effects of production activities, as well as the underground states can be monitored. The basic method is that, through arranging detectors in the well or on the ground, the small seismic events that are generated or induced in production activities can be received, and through inverting these events, the source locations of micro-seismic as well as other parameters can be obtained. In the field of shale gas hydraulic fracture micro-seismic monitoring, the signal-to-noise ratio of the micro-seismic data is relatively low. As a result, the weak events are rather difficult to be identified, and thus the source location imaging and positioning of micro-seismic weak events cannot be performed at present. There is no feasible method for existing technology to solve this technical problem.

In order to realize seismic location imaging and positioning of micro-seismic under present technology, more strong events that can be identified easily can be obtained through prolonging fracturing operation time, increasing fracturing fluid. However, the economic cost and environmental protection problems would be brought about when the above methods are used.

Therefore, in currently micro-seismic monitoring field, with respect to the low signal-to-noise ratio of the acquisition data material, a method through which valid weak events can be extracted accurately is urgently needed.

### SUMMARY OF THE INVENTION

With respect to the technical defect that the weak events cannot be identified accurately in the field of shale gas hydraulic fracture micro-seismic monitoring, the present disclosure provides a new frequency increasing processing method of a digital signal. According to the present disclosure, the frequency increasing and polarity transform processing method is referred to as zero polarity transform.

According to the present disclosure, the method comprises the steps of: inputting, in step S101, a real signal trace collected in a certain period of time; performing Hilbert transform, in step S102, on the real signal trace, so as to obtain an instantaneous amplitude trace of the real signal trace; and performing frequency increasing and polarity transform processing on the real signal trace, in step S103, based on the instantaneous amplitude trace, so as to obtain a frequency increasing signal trace.

According to one example of the present disclosure, the method further comprises the following steps after step S103, so as to further optimize the frequency increasing signal trace: performing Hilbert transform, in step S104, on the frequency increasing signal trace, so as to obtain an instantaneous cosine phase function trace of the frequency increasing signal trace; and reconstructing, in step S105, the instantaneous amplitude trace of the real signal trace and the instantaneous cosine phase function trace of the frequency increasing signal trace, so as to optimize the frequency increasing signal trace.

According to one example of the present disclosure, a reconstruction in step S105 is performed according to the following formula:

z(t)=cos ξ(t)·a(t),

wherein z(t) represents an optimized frequency increasing signal trace with zero polarity, cos ξ(t) represents the instantaneous cosine phase function trace of the frequency increasing signal trace, and a(t) represents the instantaneous amplitude trace of the real signal trace.

According to one example of the present disclosure, the frequency increasing and polarity transform processing is performed according to the following formula:

y(t)=k1·|x(t)|−k2·a(t),

wherein y(t) represents the frequency increasing signal trace, x(t) represents the real signal trace, a(t) represents the instantaneous amplitude trace of the real signal trace, and k1 and k2 are constants.

According to one example of the present disclosure, a ratio of k1 to k2 ranges from 1.2 to 2.0, and a frequency of a processed frequency increasing signal trace is a multiple of a frequency of an original real signal trace.

According to one example of the present disclosure, a value of the constant k1 is preferably 4 and a value of the constant k2 is preferably π.

According to another aspect, the present disclosure further provides a frequency increasing processing device of a digital signal, which comprises the following modules: an inputting module, used for inputting a real signal trace collected in a certain period of time; a first transformation module, used for performing Hilbert transform on the real signal trace, so as to obtain an instantaneous amplitude trace of the real signal trace; and a frequency increasing and polarity transform processing module, used for performing frequency increasing and polarity transform processing on the real signal trace, based on the instantaneous amplitude trace, so as to obtain a frequency increasing signal trace.

According to one example of the present disclosure, the device further comprises the following modules used for further optimizing the frequency increasing signal trace: a second transformation module, used for performing Hilbert transform on the frequency increasing signal trace, so as to obtain an instantaneous cosine phase function trace of the frequency increasing signal trace; and a reconstruction module, used for reconstructing the instantaneous amplitude trace of the real signal trace and the instantaneous cosine phase function trace of the frequency increasing signal trace, so as to optimize the frequency increasing signal trace.

According to one example of the present disclosure, a reconstruction in the reconstruction module is performed according to the following formula:

z(t)=cos ξ(t)·a(t),

wherein z(t) represents an optimized frequency increasing signal trace with zero polarity, cos ξ(t) represents the instantaneous cosine phase function trace of the frequency increasing signal trace, and a(t) represents the instantaneous amplitude trace of the real signal trace.

According to one example of the present disclosure, the frequency increasing and polarity transform processing in the frequency increasing and polarity transform processing module are performed according to the following formula:

y(t)=k1·|x(t)|−k2·a(t),

wherein y(t) represents the frequency increasing signal trace with zero polarity, x(t) represents the real signal trace, a(t) represents the instantaneous amplitude trace of the real signal trace, and k1 and k2 are constants.

The following beneficial effects can be brought about according to the present disclosure.

First, because the polarity of an event signal is eliminated and the frequency is increased, a valid weak event signal and an invalid interference signal are easier to be distinguished from each other. Thus, a weak signal source can be identified without a large number of strong events. This is particularly advantageous for environmental protection and cost reduction in the field of shale gas hydraulic fracture micro-seismic monitoring.

Second, the zero polarity transform and frequency increasing processing in the present invention are simple and of high versatility. Once constants k1 and k2 are given, frequency multiplying and zero polarity processing can be implemented for any signal.

Third, since the formulas according to the present disclosure are simple, a high degree of automation can be realized by a computer.

Other features and advantages of the present disclosure will be further explained in the following description, and partially become apparent, or be understood through the examples of the present disclosure. The objectives and advantages of the present disclosure will be achieved through the structure specifically pointed out in the description, claims, and the accompanying drawings.

### BRIEF DESCRIPTION OF THE DRAWINGS

FIG. 1 schematically shows a theoretical model gather and a corresponding stacked trace of simulating micro-seismic data;

FIG. 2 schematically shows a theoretical model gather and a corresponding stacked trace after a random noise is added to the model as shown in FIG. 1;

FIG. 3 is a flow chart of a method for zero polarity transform frequency increasing processing according to one example of the present disclosure;

FIG. 4a to FIG. 4f each schematically show a result after signal transform when a corresponding step as shown in FIG. 3 is preformed;

FIG. 5a schematically shows a signal trace which contains a positive polarity wavelet and a negative polarity wavelet;

FIG. 5b schematically shows a non-polarity wavelet signal trace after zero polarity transform is performed on the signal trace as shown in FIG. 5a;

FIG. 6a schematically shows a signal trace which contains a wavelet with a main frequency of 30 Hz;

FIG. 6b is a spectrum corresponding to the wavelet as shown in FIG. 6a;

FIG. 7a schematically shows a signal trace after zero polarity transform is performed on the signal trace as shown in FIG. 6a;

FIG. 7b is a spectrum corresponding to the signal trace as shown in FIG. 7a;

FIG. 8a schematically shows a signal trace which contains wavelets with different frequencies;

FIG. 8b schematically shows a signal trace after zero polarity transform is performed on each wavelet as shown in FIG. 8a;

FIG. 9 schematically shows a result and a corresponding stacked trace after zero polarity transform is performed on the model as shown in FIG. 1 according to one example of the present disclosure;

FIG. 10 schematically shows a result and a corresponding stacked trace after zero polarity transform is performed on the model as shown in FIG. 2 according to one example of the present disclosure;

FIG. 11a to FIG. 11c show actual micro-seismic strong events identification diagrams of a shale gas fracturing construction site under present technology;

FIG. 12a to FIG. 12c show the micro-seismic strong events identification diagrams after zero polarity transform is performed on the diagrams as shown in FIGS. 11a to 11c according to the present disclosure;

FIG. 13a to FIG. 13c show actual micro-seismic weak events identification diagrams of a shale gas fracturing construction site under present technology t;

FIG. 14a to FIG. 14c show the micro-seismic weak events identification diagrams after zero polarity transform is performed on the diagrams as shown in FIGS. 13a to 13c according to the present disclosure;

FIG. 15 is a relationship diagram between an occurrence time of a fracturing event and a vertical depth of a source;

FIG. 16 is a source locating three dimensional (3D) diagram of strong fracturing events; and

FIG. 17 is a well logging diagram of a shale gas fracturing construction well.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

In addition, the steps as shown in the flow chart can be executed in a computer system by a group of computer executable instructions. Although a certain logical sequence is shown in the flow chart, the steps shown or described herein can be executed in other sequences different from the one shown herein in some cases.

The principle of the present disclosure will be illustrated hereinafter taking the micro-seismic events in the field of shale gas hydraulic fracture micro-seismic monitoring as an example. However, the present disclosure is not limited by this. It can be understood by those skilled in the technical field of digital signal processing that, the method according to the present disclosure can be used in the processing of any digital signal.

### Embodiment 1

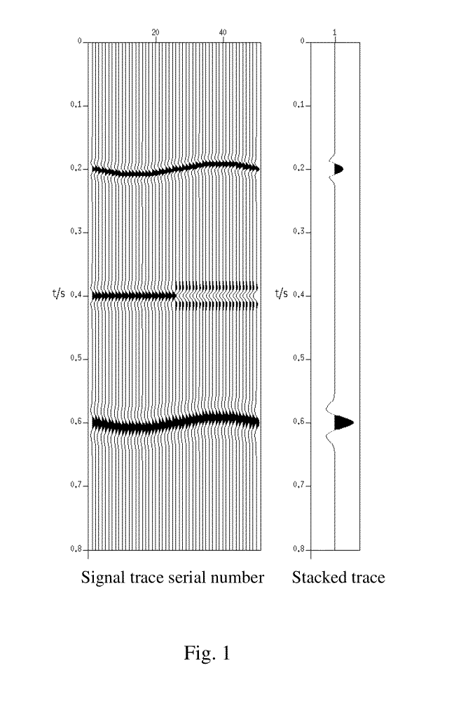

FIG. 1 schematically shows a theoretical model gather and a corresponding stacked trace of simulating micro-seismic data. As shown in FIG. 1, there are a group of distorted regular interference lineups with a frequency of 40 Hz at a moment of 0.2 s; there are another group of regular interference lineups with a same distortion and with a frequency of 20 Hz at a moment of 0.6 s; and there are a group of horizontal event lineups with non-uniform polarities and with a frequency of 30 Hz at a moment of 0.4 s. It can be seen from the stacked trace in the drawing that if there is no random noise, the two groups of regular interference lineups both can be superposed into images, while the event lineups cannot be superposed into image. The main reason for the latter case is the non-uniform polarities thereof, and the signal would be offset by each other during stacking.

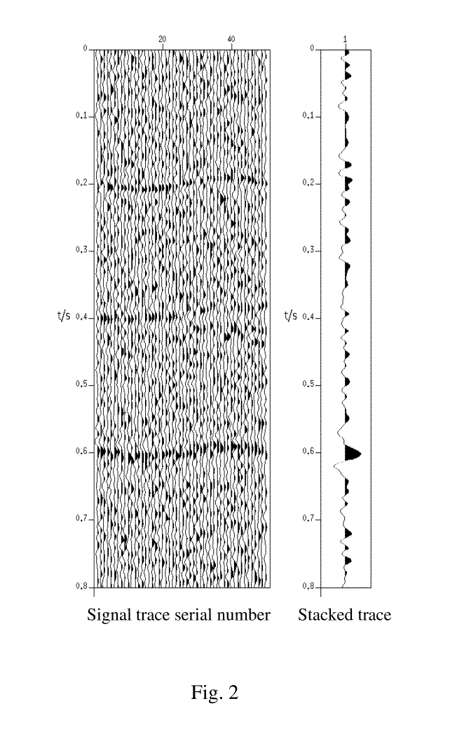

FIG. 2 schematically shows a theoretical model gather and a corresponding stacked trace after a random noise is added to the model as shown in FIG. 1. It can be seen from the stacked trace as shown in FIG. 2 that, only the regular interference lineups with the low frequency of 20 Hz at the moment of 0.6 s can be superposed into image. It is obvious that, this would lead to misjudgment in event identification. However, it should be noted that, the regular interference lineups with the high frequency of 40 Hz at the moment of 0.2 s cannot be superposed into image, which is a desirable result. This phenomenon can be interpreted by Fresnel zone principle. That is, with respect to the two groups of regular interference lineups with the same distortion, the lineups with a lower frequency are easier to be superposed into image.

It can be taught from the above phenomenon that, if the polarities of the event lineups are unified and the frequency of the signal trace which contains noise is increased, the stacking imaging of the event lineups can be obtained, the stacking imaging of the interference lineups can be reduced, and thus the misjudgment rate in event identification can be reduced.

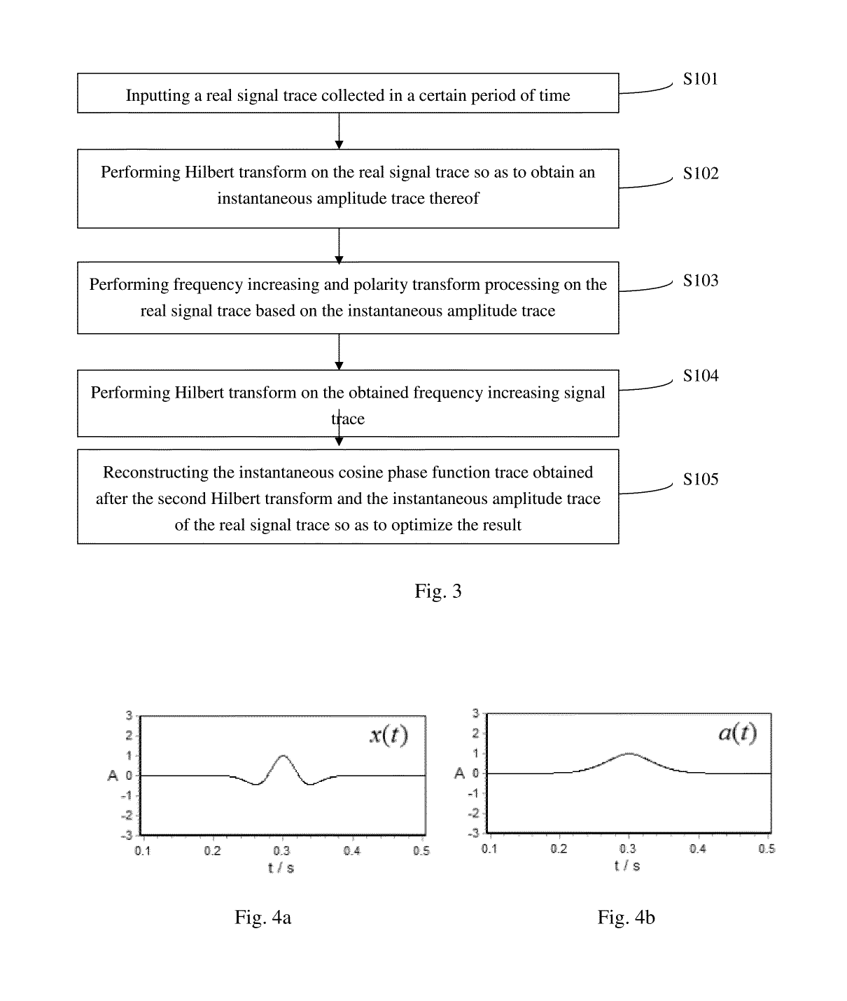

FIG. 3 is a flow chart of a method according to one example of the present disclosure. As shown in FIG. 3, in step S101, a real signal trace collected in a certain period of time is input.

Then, in step S102, Hilbert transform is performed on the real signal trace, so that an instantaneous amplitude trace of the real signal trace can be obtained.

Hilbert transform (HT) is an important tool in signal analysis. If a continuous time signal is x(t), and its Hilbert transform is h(t), the Hilbert transform can be expressed as:

$$h ( t ) = \frac{1}{π} {\int }_{- ∞}^{+ ∞} \frac{x ( t )}{t - τ} d τ , \qquad ( 1 )$$

its instantaneous amplitude can be expressed as:

a(t)=\sqrt{x²(t)+h²(t)} (2),

its instantaneous phase can be expressed as:

$$θ ( t ) = arccos ( \frac{x ( t )}{a ( t )} ) , \qquad ( 3 )$$

its instantaneous cosine phase function can be expressed as:

$$cos θ ( t ) = \frac{x ( t )}{a ( t )} , \qquad ( 4 )$$

therefore,

$$x ( t ) = cos θ ( t ) \cdot a ( t ) \qquad ( 5 )$$

it can be seen that, x(t) can be factorized into instantaneous cosine phase function cos θ(t) and instantaneous amplitude a(t).

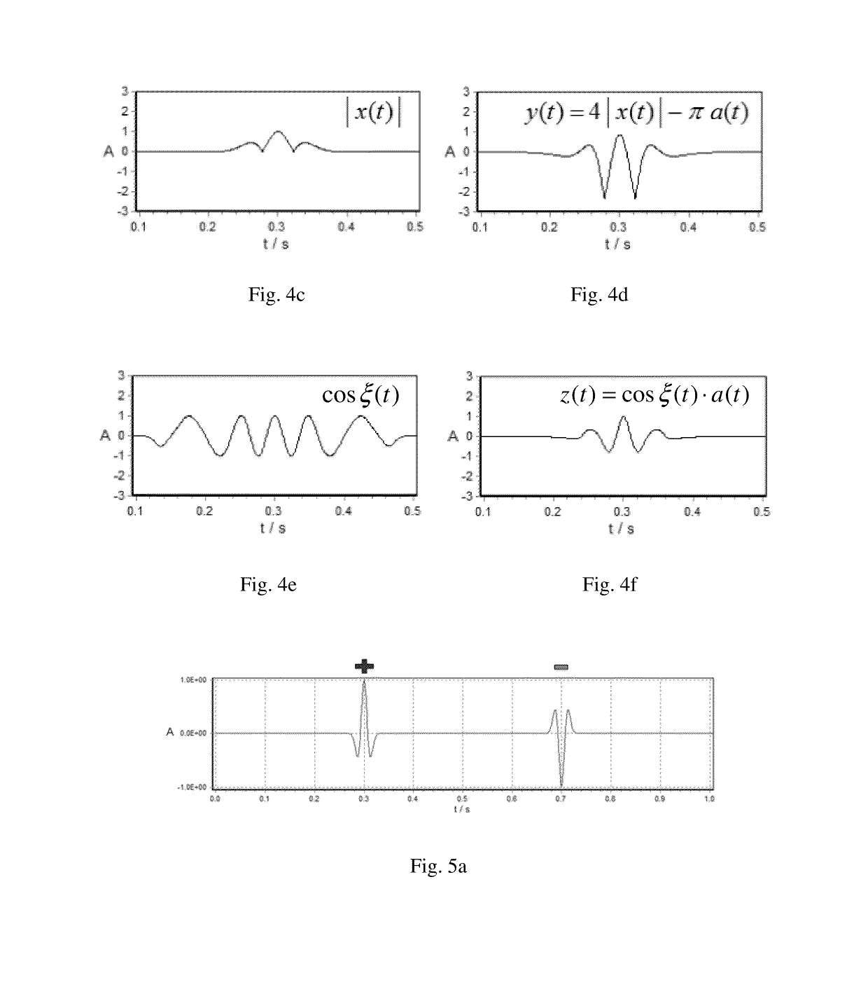

FIG. 4b schematically shows an instantaneous amplitude trace after Hilbert transform is performed on the signal trace as shown in FIG. 4a.

Next, in step S103, frequency increasing and polarity transform processing are performed on the real signal trace x(t) based on the instantaneous amplitude trace, so that a frequency increasing signal trace with zero polarity can be obtained. According to one example of the present disclosure, frequency increasing and polarity transform processing can be performed on the real signal trace based on the instantaneous amplitude trace a(t) of the real signal trace x(t). More specifically, the frequency increasing and polarity transform processing can be performed according to the following formula:

y(t)=k1·|x(t)|−k2·a(t) (6),

wherein y(t) represents the frequency increasing signal trace with zero polarity, x(t) represents the real signal trace, a(t) represents the instantaneous amplitude trace of the real signal trace x(t), and k1 as well as k2 are constants. A frequency of a processed frequency increasing signal trace is twice as a frequency of an original real signal trace. FIG. 4c and FIG. 4d respectively show signal traces after the above transformation. According to the present example, a value of the constant k1 is preferably 4 and a value of the constant k2 is preferably π. Here, the values of the constants are not limited by the above specific values. In fact, a ratio of k1 to k2 can range from 1.2 to 2.0.

According to one example of the present disclosure, the frequency increasing signal trace with zero polarity can be further optimized after step S103. For example, in step S104, Hilbert transform is performed on the frequency increasing signal trace with zero polarity, so that an instantaneous cosine phase function trace corresponding to the frequency increasing signal trace with zero polarity can be obtained. In step S105, the instantaneous amplitude trace of the real signal trace and the instantaneous cosine phase function trace of the frequency increasing signal trace with zero polarity are reconstructed, so that the frequency increasing signal trace with zero polarity can be optimized.

Specifically, a reconstruction in step S105 is performed according to the following formula:

z(t)=cos ξ(t)·a(t) (7),

wherein z(t) represents an optimized frequency increasing signal trace with zero polarity, cos ξ(t) represents the instantaneous cosine phase function trace of the frequency increasing signal trace y(t), and a(t) represents the instantaneous amplitude trace of the real signal trace x(t). The transformation procedures are shown in FIG. 4e and FIG. 4f.

In general, before step S102, Normal Move-Out (NMO) or other kinds of pre-processing can be performed on the real signal trace x(t) so as to adjust the curves. The purpose of NMO is to eliminate time differences among the wavelets of the same seismic trace arriving the ground, so as to adjust the track of the time-distance curve of source wave at a common depth point. In this case, the interference can be suppressed by horizontal stacked technology.

After the above processing, positive polarity signal and negative polarity signal both can be transformed into non-polarity signal. At the same time, the frequency of the signal can be doubled, while its physical location is not changed. It can be demonstrated through theoretical model and actual micro-seismic data experiments that, the method for frequency increasing according to the present disclosure has an obvious effect, and is highly targeted.

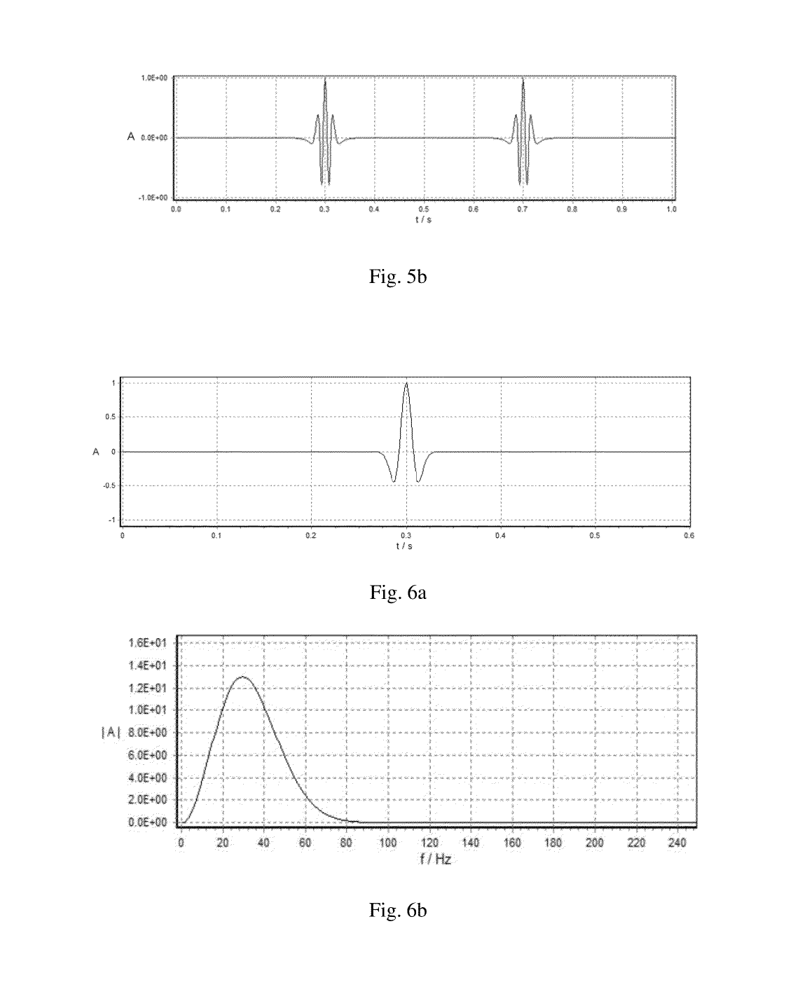

FIG. 5a schematically shows a signal trace which contains a positive polarity wavelet and a negative polarity wavelet, while FIG. 5b schematically shows a non-polarity wavelet signal trace after zero polarity transform is performed on the signal trace as shown in FIG. 5a. It can be seen from FIG. 5a and FIG. 5b that, the physical locations of the wavelets are not changed by zero polarity transform.

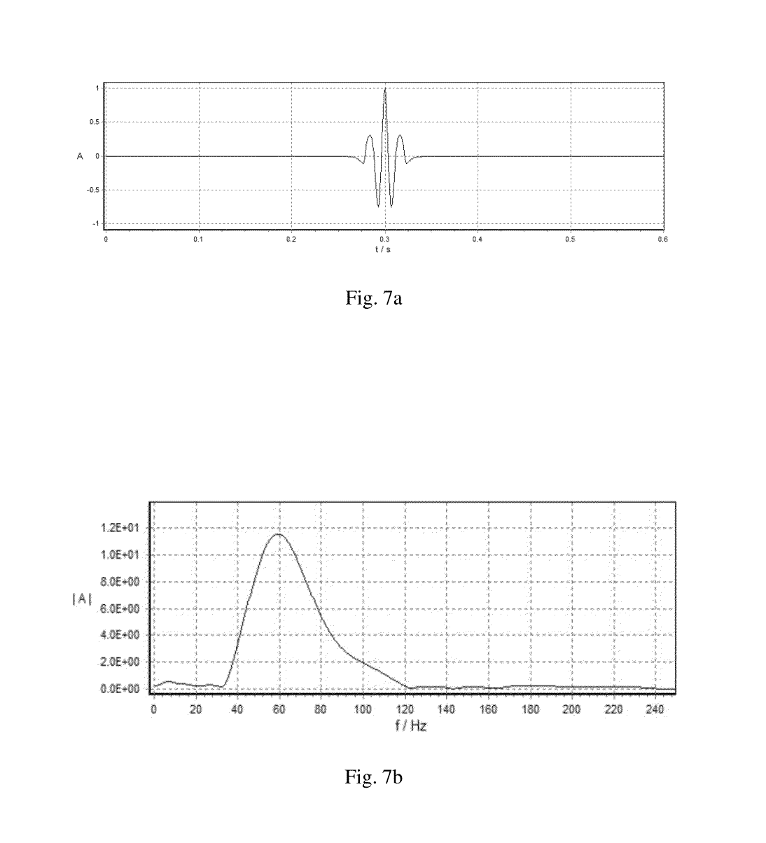

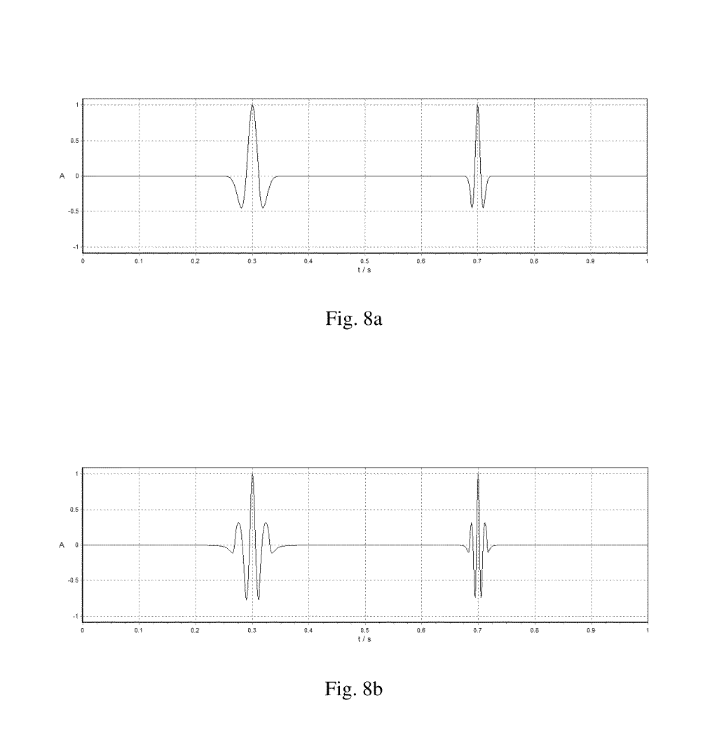

FIG. 6a schematically shows a signal trace which contains a wavelet with a main frequency of 30 Hz, and FIG. 6b is a spectrum corresponding to the wavelet as shown in FIG. 6a. FIG. 7a schematically shows a signal trace after zero polarity transform is performed on the signal trace as shown in FIG. 6a, and FIG. 7b is a spectrum corresponding to the signal trace as shown in FIG. 7a. It can be seen from the spectrum as shown in FIG. 7b that, the main frequency of the wavelet is 60 Hz. The frequency of the signal can be doubled after zero polarity transform is performed according to the method of the present disclosure.

As shown in FIG. 7b, zero polarity transform is also restricted by the maximum frequency fₘₐₓ of the sampling theorem. When the frequency f of the original signal is larger than 0.5 fₘₐₓ, alias phenomenon would occur after zero polarity transform. However, the essence is not affected by the alias phenomenon.

FIG. 8a schematically shows a signal trace which contains wavelets with different frequencies. As shown in FIG. 8a, there is a wavelet with a frequency of 20 Hz at a moment of 0.3 s, and there is a wavelet with a frequency of 40 Hz at a moment of 0.7 s. FIG. 8b schematically shows a signal trace after zero polarity transform is performed on each wavelet as shown in FIG. 8a. As shown in FIG. 8b, the frequency of the wavelet at the moment of 0.3 s is increased to be 40 Hz, and the frequency of the wavelet at the moment of 0.7 s is increased to be 80 Hz. It is demonstrated that, the frequency of the whole signal trace is increased by zero polarity transform, i.e., the frequency of each wavelet of the signal trace is doubled on the basis of the original frequency.

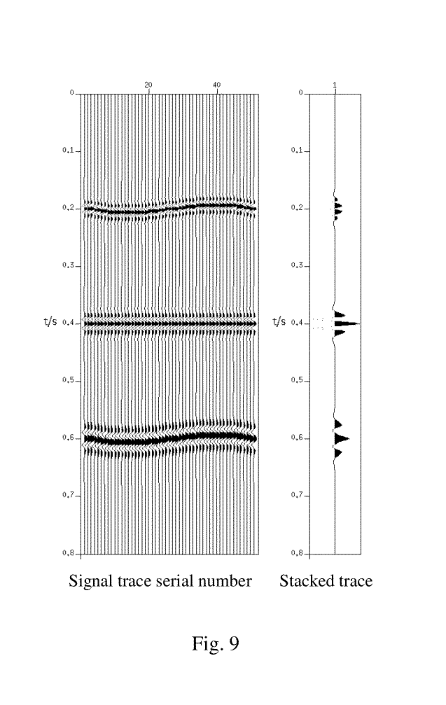

FIG. 9 schematically shows a result and a corresponding stacked trace after zero polarity transform is performed on the theoretical model gather as shown in FIG. 1. As shown in FIG. 9, the frequency of the group of distorted regular interference lineups at the moment of 0.2 s is increased to be 80 Hz from the original 40 Hz, the frequency of another group of regular interference lineups with the same distortion at the moment of 0.6 s is increased to be 40 Hz from the original 20 Hz, and the frequency of the group of horizontal event lineups with non-uniform polarities at the moment of 0.4 s is increased to be 60 Hz from the original 30 Hz. In addition, the polarity of the event lineups is uniformed. It can be seen from the stacked trace as shown in FIG. 9 that, the three groups of lineups all can be superposed into images in the case that there is no random noise.

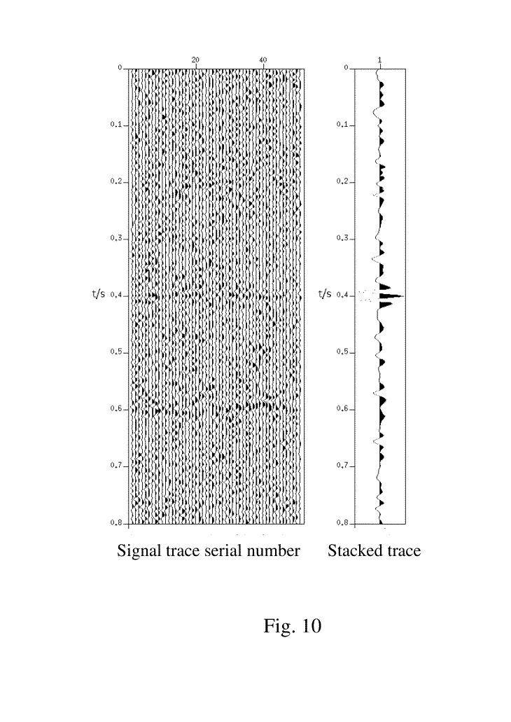

FIG. 10 schematically shows a result and a corresponding stacked trace after zero polarity transform is performed on the theoretical model gather containing noise as shown in FIG. 2. It can be seen from the stacked trace as shown in FIG. 10 that, only the group of horizontal event lineups at 0.4 s can be superposed into image. It can be seen from the comparison between FIG. 2 and FIG. 10 that, the regular interference lineups of high frequency are not easy to be superposed into image on the condition of low signal-to-noise ratio. If automatic identification or manual identification is performed on the basis of FIG. 10, the misjudgment rate in event identification can be significantly reduced.

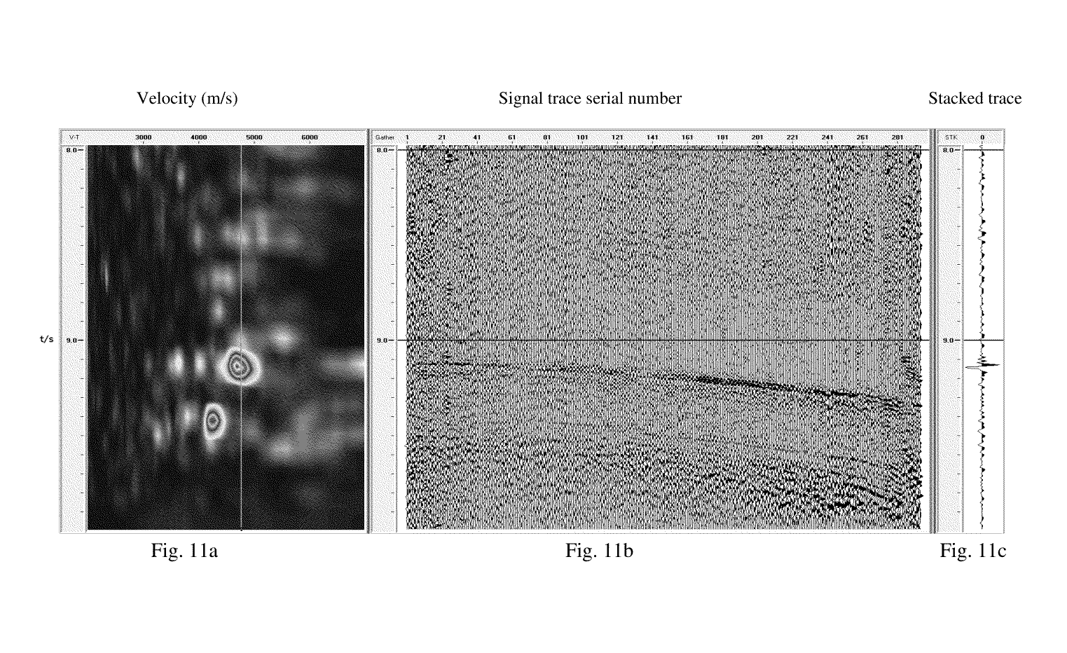

FIG. 11a to FIG. 11c show actual micro-seismic strong events identification diagrams of a shale gas fracturing construction site. FIG. 11a is a scanning stacked energy group velocity spectrum of a micro-seismic gather. FIG. 11b shows a micro-seismic super gather before NMO is performed, wherein part of the polarities are offset since the polarities of the events are non-uniform. FIG. 11c shows a horizontal stacked trace after NMO is performed on the gather as shown in FIG. 11b. Since this event is a strong event, it is very easy to identify the strong event as shown in FIG. 11 on the condition of high signal-to-noise ratio.

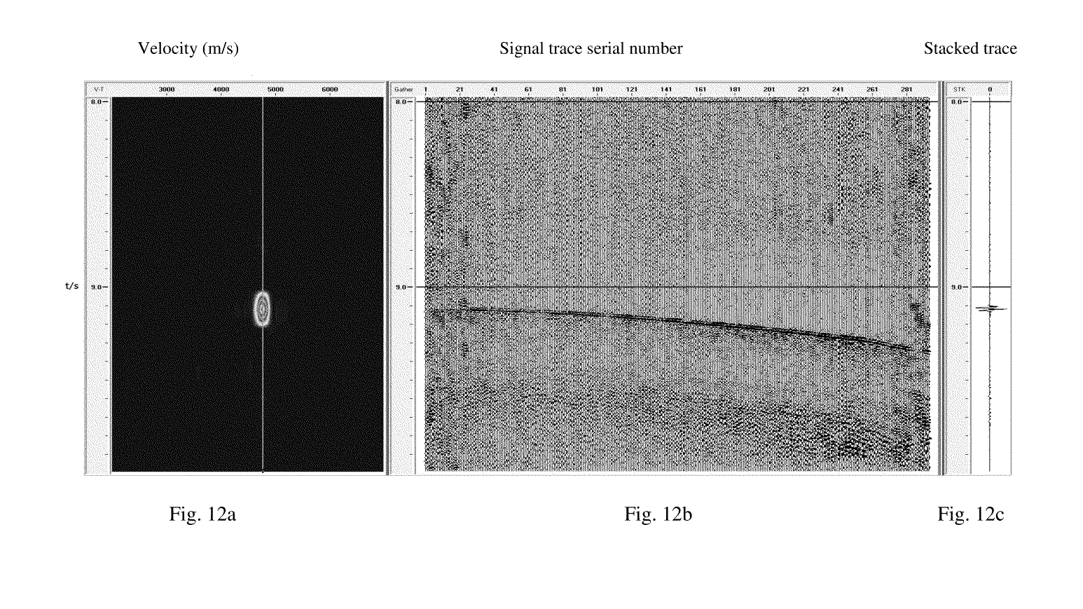

FIG. 12a to FIG. 12c show the micro-seismic strong event identification diagrams after zero polarity transform is performed on the diagrams as shown in FIG. 11. FIG. 12a is a scanning stacked energy group velocity spectrum of a micro-seismic gather after zero polarity transform, wherein the strong event energy group becomes clearer. FIG. 12b shows a micro-seismic super gather before NMO is performed while after zero polarity transform, and the polarity offset phenomenon disappears. FIG. 12c shows a horizontal stacked trace after NMO is performed on the gather as shown in FIG. 12b, wherein the physical location of the stacking imaging result is not changed.

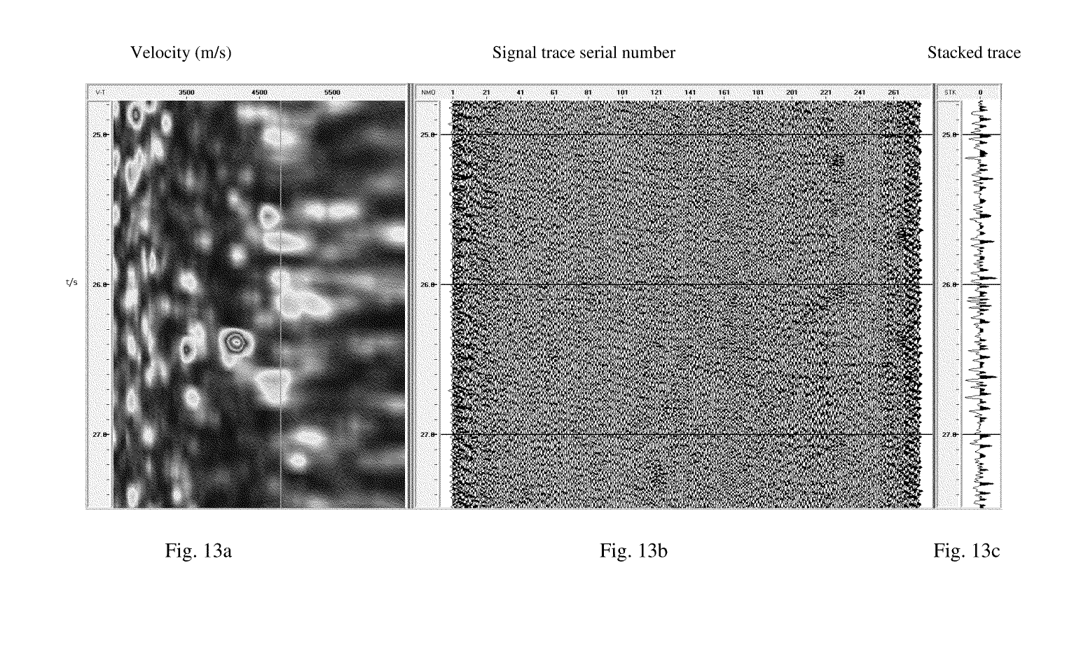

FIG. 13a to FIG. 13c show actual micro-seismic weak events identification diagrams of a shale gas fracturing construction site. FIG. 13a is a scanning stacked energy group velocity spectrum of a micro-seismic gather. FIG. 13b shows a micro-seismic super gather after NMO is performed. Since parts of the polarities are offset due to the non-uniform polarities of the events, the horizontal event lineups cannot be seen. FIG. 13c is a horizontal stacked trace of the gather as shown in FIG. 13b. Similarly, these weak events cannot be superposed into image because of the polarity offset phenomenon. It is obvious that, the weak events as shown in FIG. 13 are very difficult to be identified on the condition of low signal-to-noise ratio.

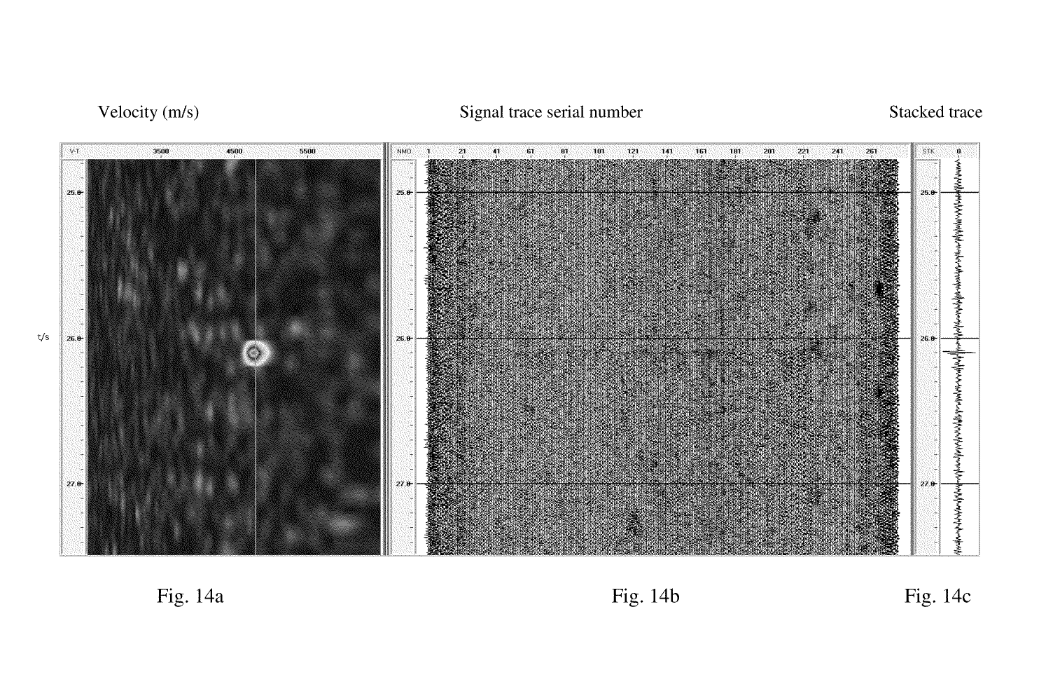

FIG. 14a to FIG. 14c show the micro-seismic weak events identification diagrams after zero polarity transform is performed on the diagrams as shown in FIG. 13. FIG. 14a is a scanning stacked energy group velocity spectrum of a micro-seismic gather after zero polarity transform. There is a clear energy group at 26.1 s. FIG. 14b shows a micro-seismic super gather after NMO is performed and after zero polarity transform, wherein horizontal event lineups can be seen at the same moment. FIG. 14c is a horizontal stacked trace of the gather as shown in FIG. 14b. It is demonstrated by the stacking imaging result that, a fracturing weak event occurs at 26.1 s.

It is demonstrated by theoretical model and the results of actual micro-seismic data experiments that, the polarities of the event lineups can be uniformed by zero polarity transform, and the polarity offset phenomenon can be eliminated, so that the event lineups can be superposed into image. The frequency of the signal trace which contains noise can be doubled by zero polarity transform, and thus the random noise or interference lineups can hardly be superposed into image in a high frequency state. In addition, after zero polarity transform, the physical location of the signal is not changed, so that a correctness of the result of source inversion can be ensured.

### Embodiment 2

According to another aspect of the present disclosure, the aforesaid method can be implemented in a computer device. The computer device and other peripheral circuits can constitute a digital signal processing device. The device comprises the following modules: an inputting module, used for inputting a real signal trace collected in a certain period of time; a first transformation module, used for performing Hilbert transform on the real signal trace, so as to obtain an instantaneous amplitude trace of the real signal trace; and a frequency increasing and polarity transform processing module, used for performing frequency increasing and polarity transform processing on the real signal trace, based on the instantaneous amplitude trace, so as to obtain a frequency increasing signal trace with zero polarity.

Preferably, the device further comprises the following modules used for further optimizing the frequency increasing signal trace with zero polarity: a second transformation module, used for performing Hilbert transform on the frequency increasing signal trace with zero polarity, so as to obtain an instantaneous cosine phase function trace of the frequency increasing signal trace with zero polarity; and a reconstruction module, used for reconstructing the instantaneous amplitude trace of the real signal trace and the instantaneous cosine phase function trace of the frequency increasing signal trace with zero polarity, so as to optimize the frequency increasing signal trace with zero polarity.

The reconstruction in the reconstruction module is performed according to the following formula:

z(t)=cos ξ(t)·a(t),

wherein z(t) represents an optimized frequency increasing signal trace with zero polarity, cos ξ(t) represents the instantaneous cosine phase function trace of the frequency increasing signal trace, and a(t) represents the instantaneous amplitude trace of the real signal trace.

In the frequency increasing and polarity transform processing module, the frequency increasing and polarity transform processing are performed on the real signal trace based on the instantaneous amplitude trace of the real signal trace. Specifically, the frequency increasing and polarity transform processing are performed according to the following formula:

y(t)=k1·|x(t)|−k2·a(t),

wherein y(t) represents the frequency increasing signal trace with zero polarity, x(t) represents the real signal trace, a(t) represents the instantaneous amplitude trace of the real signal trace, and k1 and k2 are constants.

### Embodiment 3

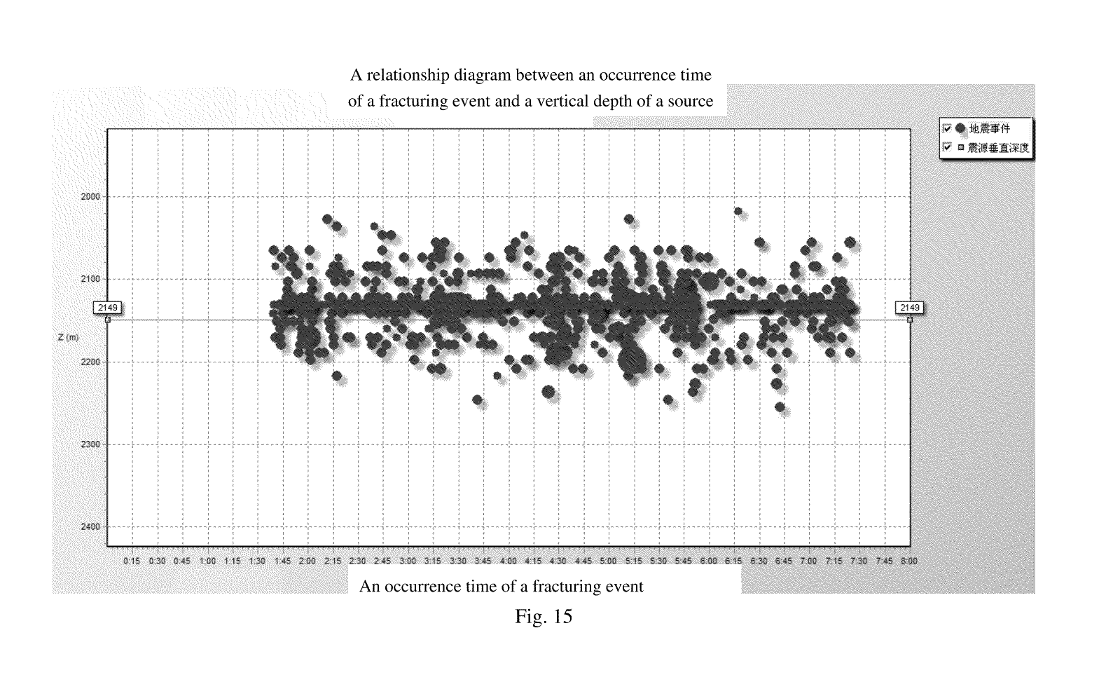

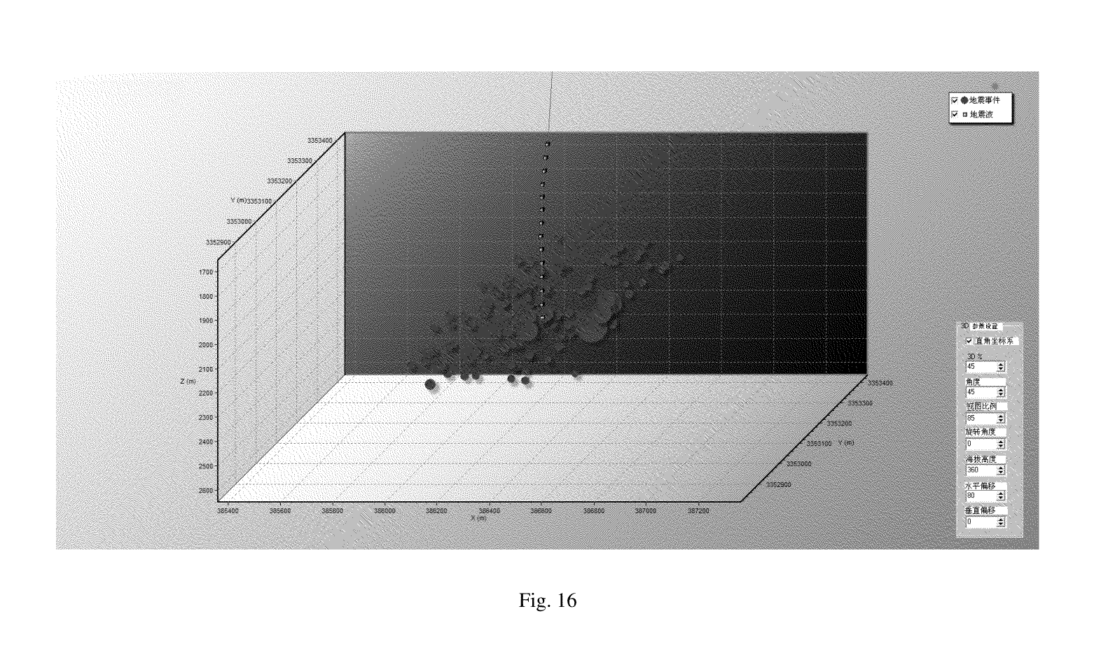

The fracturing monitoring data of a shale gas well in a construction site are batch processed according to the method of the present disclosure, and 879 fracturing events and source locations can be obtained. There are 127 strong fracturing events, and others are weak fracturing events. FIG. 15 is a relationship diagram between an occurrence time of each of the 879 fracturing events and a vertical depth of a source. FIG. 16 is a source locating three dimensional (3D) diagram of the 127 strong fracturing events.

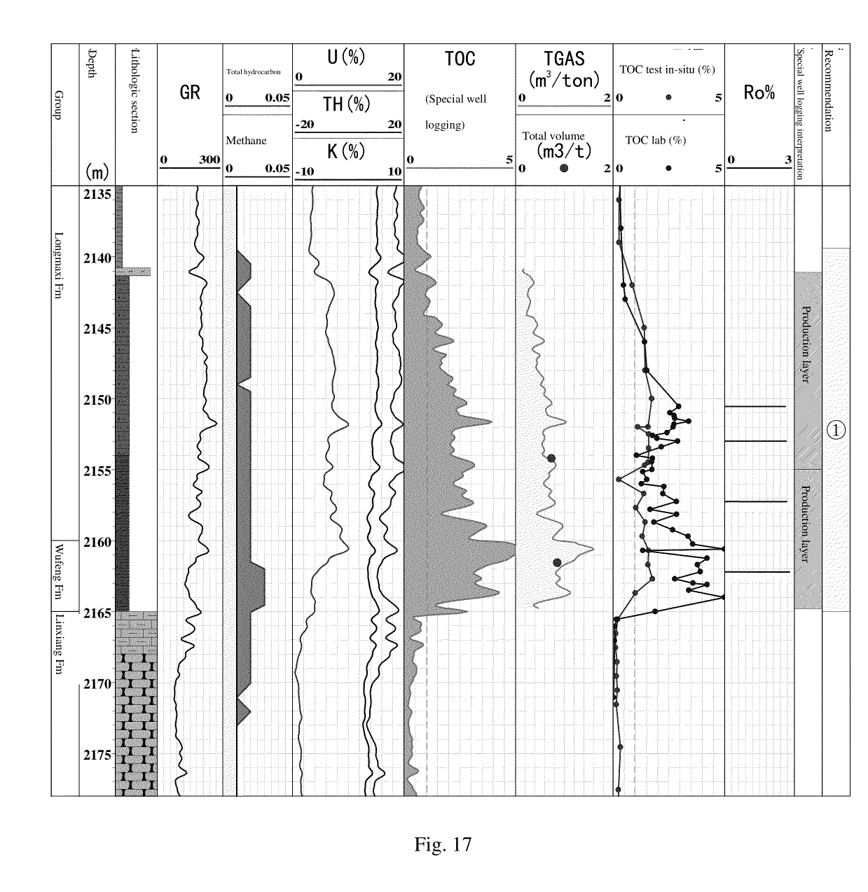

As shown in FIG. 15, there is a horizontal thin layer with a small stress in a vertical depth of 2132 m (a measured depth is 2141 m), and the weak fracturing events occur in this layer in a concentrated manner. This conclusion is verified by the well logging diagram (FIG. 17) of the well (the depths as shown in FIG. 17 are all measured depths).

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A frequency increasing processing method of a digital signal, comprising the steps of:
inputting, in step S101, a real signal trace collected in a certain period of time;
performing Hilbert transform, in step S102, on the real signal trace, so as to obtain an instantaneous amplitude trace of the real signal trace; and
performing frequency increasing and polarity transform processing on the real signal trace, in step S103, based on the instantaneous amplitude trace, so as to obtain a frequency increasing signal trace.

2. The method according to claim 1, further comprising the following steps after step S103 so as to further optimize the frequency increasing signal trace:
performing Hilbert transform, in step S104, on the frequency increasing signal trace, so as to obtain an instantaneous cosine phase function trace of the frequency increasing signal trace; and
reconstructing, in step S105, the instantaneous amplitude trace of the real signal trace and the instantaneous cosine phase function trace of the frequency increasing signal trace, so as to optimize the frequency increasing signal trace.

3. The method according to claim 2, wherein a reconstruction in step S105 is performed according to the following formula:
z(t)=cos ξ(t)·a(t),
wherein z(t) represents an optimized frequency increasing signal trace, cos ξ(t) represents the instantaneous cosine phase function trace of the frequency increasing signal trace, and a(t) represents the instantaneous amplitude trace of the real signal trace.

4. The method according to claim 1, wherein the frequency increasing and polarity transform processing in step S103 is performed according to the following formula:
y(t)=k1·|x(t)|−k2·a(t),
wherein y(t) represents the frequency increasing signal trace, x(t) represents the real signal trace, a(t) represents the instantaneous amplitude trace of the real signal trace, and k1 and k2 are constants.

5. The method according to claim 4,
wherein a ratio of k1 to k2 ranges from 1.2 to 2.0; and
wherein a frequency of a processed frequency increasing signal trace is a multiple of a frequency of an original real signal trace.

6. The method according to claim 5, wherein a value of the constant k1 is 4 and a value of the constant k2 is π.

7. A frequency increasing processing device of a digital signal, comprising the following modules:
an inputting module, used for inputting a real signal trace collected in a certain period of time;
a first transformation module, used for performing Hilbert transform on the real signal trace, so as to obtain an instantaneous amplitude trace of the real signal trace; and
a frequency increasing and polarity transform processing module, used for performing frequency increasing and polarity transform processing on the real signal trace, based on the instantaneous amplitude trace, so as to obtain a frequency increasing signal trace.

8. The device according to claim 7, further comprising the following modules used for further optimizing the frequency increasing signal trace:
a second transformation module, used for performing Hilbert transform on the frequency increasing signal trace, so as to obtain an instantaneous cosine phase function trace of the frequency increasing signal trace; and
a reconstruction module, used for reconstructing the instantaneous amplitude trace of the real signal trace and the instantaneous cosine phase function trace of the frequency increasing signal trace, so as to optimize the frequency increasing signal trace.

9. The device according to claim 7, wherein a reconstruction in the reconstruction module is performed according to the following formula:
z(t)=cos ξ(t)·a(t),
wherein z(t) represents an optimized frequency increasing signal trace, cos ξ(t) represents the instantaneous cosine phase function trace of the frequency increasing signal trace, and a(t) represents the instantaneous amplitude trace of the real signal trace.

10. The device according to claim 7, wherein the frequency increasing and polarity transform processing in the frequency increasing and polarity transform processing module are performed according to the following formula:
y(t)=k1·|x(t)|−k2·a(t),
wherein y(t) represents the frequency increasing signal trace, x(t) represents the real signal trace, a(t) represents the instantaneous amplitude trace of the real signal trace, and k1 and k2 are constants.
